(19) United States
(12) Patent Application Publication
(10) Pub. No.: US 2014/0157158 A1
(43) Pub. Date: Jun. 5, 2014

(54) SYSTEM AND METHOD FOR VISUALLY IDENTIFYING USER PREFERENCES

(71) Applicants: Martin Camins, Waterloo (ON); Nathan Seiling, Elora (ON)

(72) Inventors: Martin Camins, Waterloo (ON); Nathan Seiling, Elora (ON)

(21) Appl. No.: 14/094,115

(22) Filed: Dec. 2, 2013

Related U.S. Application Data
(60) Provisional application No. 61/732,605, filed on Dec. 3, 2012.

(51) Int. Cl. G06F 3/0481

(52) U.S. Cl. CPC G06F 3/0481
USPC 715/765

(57) ABSTRACT

A method and system for visually identifying user preferences on a touchscreen computing device is described. The system for visually identifying user preferences can be implemented on a plurality of touchscreen devices including smart phones, tablet computers and personal computers equipped with a touchscreen user interface. In one example, any visual image in a plurality of image formats supported by the touchscreen device can be used to identify specific areas of the image that visually appeals to the user.

### RELATED APPLICATIONS

This application claims the benefit of U.S. Provisional Application No. 61/732,605, filed Dec. 3, 2012, the entirety of which is herein incorporated by reference.

### BACKGROUND

Computing devices such as smart phones and tablets are one of the fastest growing segments in the computer and communications industries. These emerging technologies are exhibiting significant global adoption and are changing the way people manage many aspects of their daily lives including business, communication, social interaction, financial transactions, leisure and entertainment. User efficiency and productivity is improved through simplicity and mobility, providing access to information at anytime from anywhere.

Many mobile computing devices are designed to enhance the user experience through intuitive, easy to use interfaces including touch and voice activation, making technology accessible to non-technical individuals of all ages.

A growing number of software and web-based applications available today are designed to gather information on individual interests and preferences in order to identify their likes and dislikes on a variety of topics. Based on that information, companies can target specific products and services to those individuals.

### SUMMARY

Identifying specific areas (e.g., portions, sections, etc.) of an image that appeals to an individual user can provide useful information on user preferences from a visual perspective. This disclosure provides a system and method for visually identifying user preferences.

The system for visually identifying user preferences can be implemented on a plurality of computing devices including mobile, touchscreen devices such as smart phones, tablet computers and personal computers equipped with a touchscreen user interface. Alternatively, a standard personal computer having a mouse-cursor interface can be used with this disclosure. Any visual image in a plurality of image formats supported by the touchscreen device can be used to identify specific areas of the image that visually appeals to the user.

In accordance with one embodiment of the present disclosure, the system will present a filtered set of images based on categories of interest selected by the user.

To identify the specific areas of preference, the user simply touches a specific location on each image and a button icon labeled “LIKE” will appear on the image at the touch point.

Alternatively, the user can touch a “LIKE” button icon beside the image and drag and drop it on an area of preference.

Another embodiment of this disclosure allows the user to precisely specify the aspect of the area the user likes by selecting an item from a list of options or by adding a brief description after specifying an area of preference on the image. Yet another embodiment of this disclosure allows the user to identify specific areas of the image that do not appeal to the user visually.

A further embodiment of this disclosure allows the user to select the degree of preference of a specific section of the image through a sliding scale. Alternatively, the user can select from different button icons such as “LIKE”, “DISLIKE”, “LOVE” and “HATE” beside the image and either touch an area on the image after touching a button icon, or drag and drop the button icon on an area of preference.

The system can generate a report that identifies and details the user preference selections visually.

In an alternate embodiment of this disclosure, the system can capture and store the visual preferences in a data store and generate a report that provides user preference data through the utilization of pre-defined categorized sections associated with different areas of the image. Data collected by the system can be used to generate statistical information that may be analyzed to determine user preference trends.

In a further embodiment of this disclosure, the system can display details or specifications of the specific section of the image selected (touched) by the user.

In a further embodiment of this disclosure, a user is presented with a series of images. The user is then allowed to select images from the series that it liked. In response to the specific images liked by the user, the user's preferences can then be determined.

In still a further embodiment of this disclosure, a subset of images is shown to the user in response to the determined preferences of the user for a first series of images, and the user is allowed to indicate which of the images from the subset it likes. In one example, the preferences of the user are refined based on the reaction of the user to the images in the subset.

In another embodiment of this disclosure, the image is presented to a user in the form of a video. The user is allowed to indicate its preference for specific portions, or segments, of the video. Based on the reaction of the user to the video, the preferences of the user can then be determined.

The embodiments, examples and alternatives of the preceding paragraphs, the claims, or the following description and drawings, including any of their various aspects or respective individual features, may be taken independently or in any combination. Features described in connection with one embodiment are applicable to all embodiments, unless such features are incompatible.

### DRAWINGS

The drawings can be briefly described as follows.

FIG. 1 schematically illustrates an example system of this disclosure.

FIG. 2 schematically represents an example computing device of the system of FIG. 1.

FIG. 3 is a block diagram representing an example method of this disclosure.

FIG. 4 is a computing device displaying an image with individually selectable portions.

FIG. 5 is a computing device displaying another image with individually selectable portions.

FIG. 6 is a block diagram representing another example method of this disclosure.

### DESCRIPTION

A first aspect of this disclosure provides a user with the ability to visually identify preferences for specific aspects of an image or images via an intuitive user interface (e.g., a touchscreen). A second aspect of this disclosure provides a user with the ability to take the data generated from the user preferences and make it available for the creation of meaningful reports and results for commercial benefit. These two aspects may be used together, or separately, depending on the application.

Additional aspects of this disclosure relate to system flexibility and scalability. First, the system can be customized based on a system configuration without the need for redesigning the system. Second, the system can intelligently present a filtered subset of data and images from an overall database of information and images based on categories of interest selected by the user, so that the user is presented with data and information that is relevant to their specific requirements.

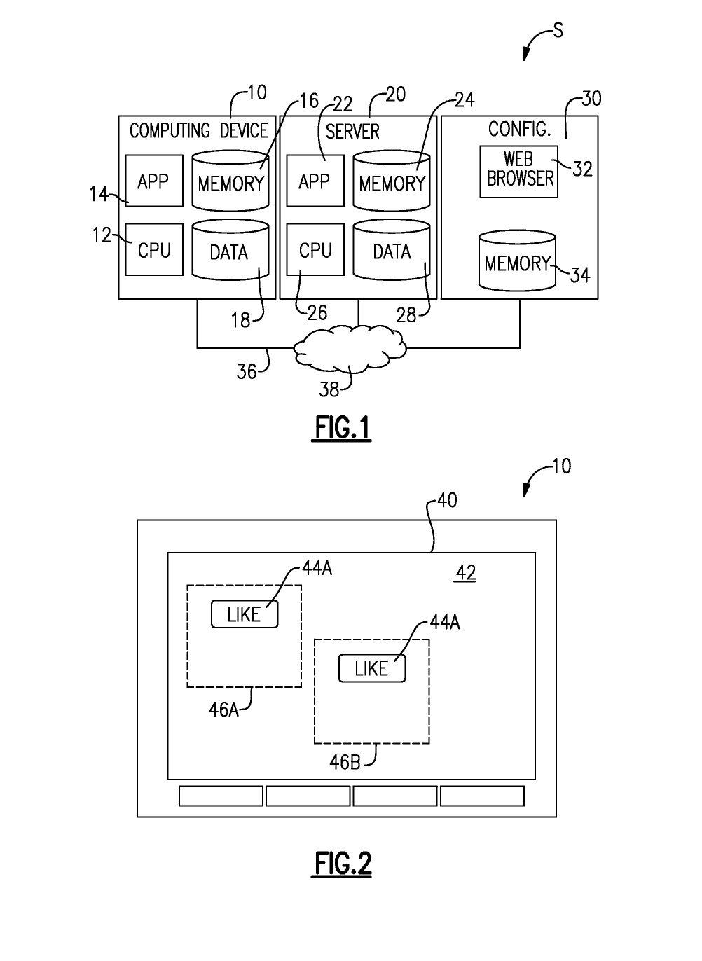

A system S of present disclosure is illustrated in FIG. 1. The system S includes a computing device 10 which may be in the form of a tablet, smartphone, portable or personal computer equipped with a screen, that may be touchscreen in some examples. In either case, the computing device 10 is equipped with a central processing unit (CPU) 12 executing a software application (APP) 14 loaded in program memory 16. The computing device 10 also has a data store 18 (or, database 18) that locally stores user data. The system S also includes a configuration computer 30 that is used to customize the APP 14 running on the computing device 10, and a server computer 20 that stores both user data collected from the computing device 10 and configuration data collected from the configuration computer 30.

In one example, a software application (APP) 22 loaded in memory 24 executed by the CPU 26 of the server computer 20 (or, server 20) takes the incoming user data and stores it in the systems main (central) database 28. Data collected from different users can be used for data mining and statistical analysis to provide commercially useful information.

A system administrator may interact with the system via the configuration computer 30. Configuration information and custom data can be entered through a web browser 32 running in memory 34. The configuration information and custom data entered via the configuration computer 30 may be transferred over the network 36 through the cloud 38 and stored directly to the main database 28 of the server computer 20 by the APP 22 running on the server computer.

A user interacts with the system S by selecting specific locations on the screen of the computing device 10 to specify user selections and preferences. Data resulting from individual user selections and preferences are stored in the local database 18. This local user data is then transmitted over a wired or wireless network 36 from the computing device 10 over the cloud (i.e., the internet) 38 to the server computer 20.

Configuration and custom data stored on the server computer 20 can be retrieved by the computing device 10 to customize the APP 14. This process is referred to as synchronizing the data between the computing device 10 and the server computer 20. This “customization” can affect or change the behavior and characteristics of the APP 14. For instance, different information including text and images can be changed or updated in the APP 14. In effect, the APP 14 running on the computing device 10 can essentially evolve into a completely new APP without the need to update, create or develop a new or different software application.

A subsystem within the system S is illustrated in FIG. 2. The subsystem, which is a part of the computing device 10 in FIG. 1, includes a screen 40 on which an image 42 is rendered by execution of the APP 14, based on categories of interest selected by the user in one example. In one example, the screen 40 is a touchscreen. In another example, the screen 40 is a standard personal computer screen, and a user is capable of interacting with the image via a mouse-cursor interface, as one example.

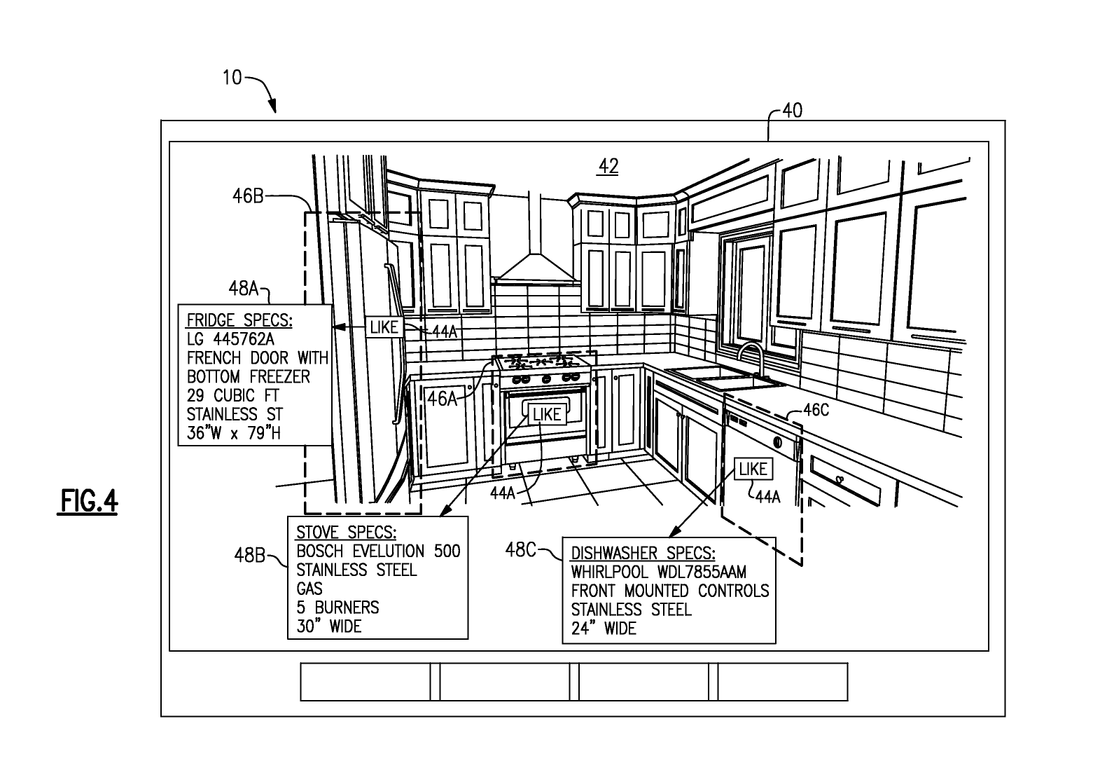

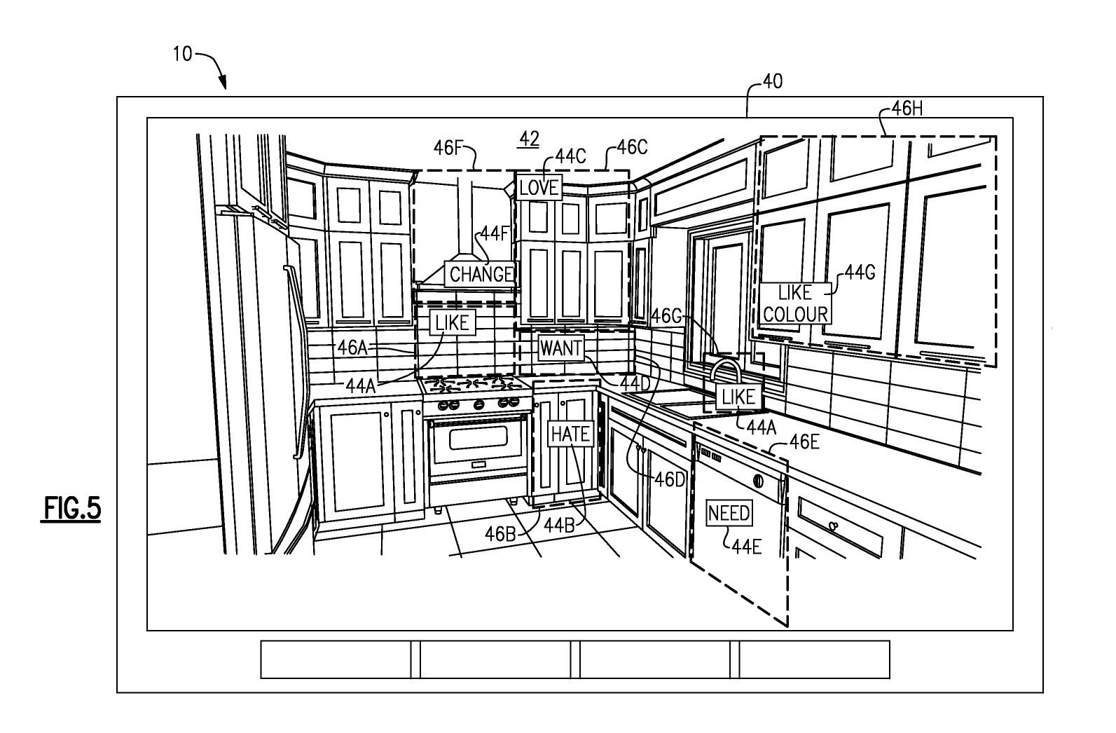

In a particular embodiment of this disclosure, the image 42 may be subdivided into predefined sections or image areas 46A-46B. The areas 46A-46B may be presented to the user, or may exist only in the background for purposes of correlating a particular image area to an element depicted within that area. While two sections 46A-46B are illustrated in FIG. 2, the image 42 may be subdivided into additional areas (as in FIGS. 4-5, discussed below).

In the example where the screen 40 is a touchscreen, a user interacts with the system by touching specific locations on the screen 40 to specify user selections and preferences. More specifically, in one example the user identifies specific areas 46A-46B of the image 42 that are visually appealing. While the areas (e.g., 46A-46B) are referred to above as being “predefined,” in some examples the areas are not predefined, and the user is allowed to select every portion of an image it finds appealing. In this case, the user inputs may correlated to particular elements depicted in the image in another (potentially separate) step. Any visual image in a plurality of image formats supported by the computing device 10 can be used to identify visual preferences of the user.

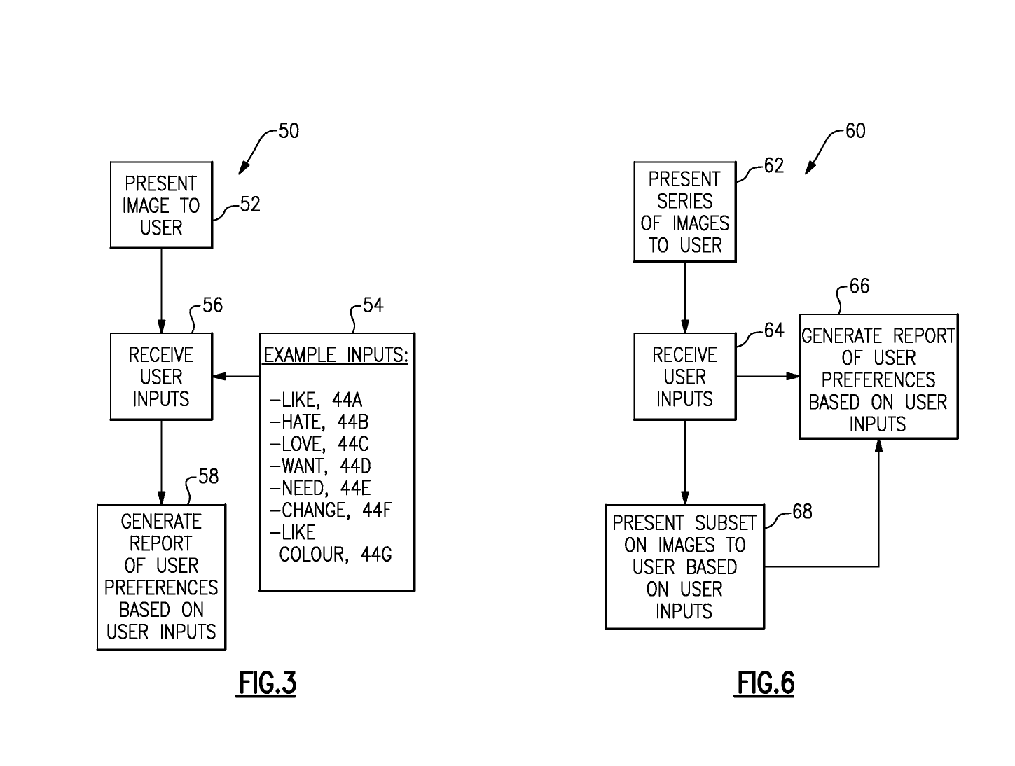

One example method 50 of this disclosure is schematically illustrated in FIG. 3. In the method 50, the APP 14 will present at least one image to the user, at 52, based on a category of interest, for example. User inputs (schematically shown at 54) are received by the computing device 10, at 56. In one example, to identify the specific areas of preference, the user touches a specific location on the image 42 and a button icon 44A labeled “LIKE” will appear on the image at the touch point. Alternatively, the user can touch a “LIKE” button icon 44A beside the image 42 and drag and drop it on an area of preference 46. When the “LIKE” button icon 44A is moved and released, it will remain at the location of the image 42 where it was released (i.e., where the user lifted their finger from the screen 40). Other methods of associating the “LIKE” button icon 44A with the various areas 46A-46B come within the scope of this disclosure. After the inputs are received they are compiled into a report, at 58.

In one example, the user is presented with an image of a model kitchen. The user can then indicate its overall preference for the image, or can indicate its preference for certain areas within the image corresponding to certain features of the model kitchen (e.g., a refrigerator, cabinetry, etc.). This disclosure extends to other fields, however, and is not limited to the construction and home remodeling industries.

For the purposes of providing an example, FIG. 4 includes an example image 42, which is an image of a model kitchen. The image 42 includes a plurality of predefined areas 46A-46C associated with either a fixture or an appliance within the kitchen. In this example, the predefined areas 46A-46C are associated with the stove, refrigerator, and dishwasher, respectively. Other example image areas may be associated with cabinetry, a sink, a backsplash, a countertop, etc.

In FIG. 4, the user has indicated that it likes each of the stove, the refrigerator, and dishwasher by associating the “LIKE” button icon 44A with the predefined areas 46A-46C. The user may indicate it likes the elements in the areas 46A-46C based on aesthetic appeal, or based on additional information, such as design specifications.

In FIG. 4, the user also has the option of revealing design specifications 48A-48C (or, specs 48A-48C) associated with the elements in areas 46A-46C. In FIG. 4, the user has revealed the fridge specs, stove specs, and dishwasher specs 48A-48C, respectively. The user may use the specs 48A-48C when indicating its preference for the elements in the areas 46A-46C. Alternatively, the APP 14 will be programmed to reveal the specs 48A-48C after the user likes the elements in areas 46A-46C to provide the user with information about the elements it has liked.

Another embodiment of this disclosure is explained with reference to FIG. 5. FIG. 5 includes a plurality of predefined areas 46A-46H associated with various elements in a model kitchen, generally in the same way described above relative to FIG. 4. In this example, the areas 46A-46H are associated with a first backsplash section, a first set of cabinets, a second set of cabinets, a second backsplash section, a dishwasher, a range hood, a faucet, and a third set of cabinets, respectively.

The user is allowed to precisely specify its preference for certain areas 46A-46H, by selecting an icon from a list potential button icons, or by adding a brief description after specifying an area of preference on the image 42. For instance, as illustrated in FIG. 5, the user may identify specific areas of the image 42 that do not appeal to the user visually using for instance a “DISLIKE” or “HATE” button icon 44B. In FIG. 5, the user has indicated that its dislikes the cabinets within area 46B by placing a “HATE” button icon 44B within the area 46B. Additional button icons include “LIKE” 44A, “HATE” 44B, “LOVE” 44C, as well as “WANT” 44D, “NEED” 44E, and “CHANGE” 44F. Further still, a user may indicate an intermediate level of preference for a particular item by selecting a button icon such as “CHANGE COLOUR” 44G, which would be selected, in one example, if a user likes the design of the cabinets within area 46H, but dislikes the colour.

While buttons such as “LIKE” and “HATE” are discussed above, the system S can include alternate button icons. In one example, a green circle or a heart could represent “LIKE” while a red octagon (stop sign) could indicate “HATE.” Additional button icons come within the scope of this disclosure, and it should be understood that this disclosure is not limited to any one type of button icon.

In a further embodiment of this disclosure, the system S can display details or specifications of the specific area 46 of the image 42 selected (touched) by the user on the screen 40. These details and/or specifications may be included in a report (discussed below) generated by the system upon completion of the APP 14 on the computing device 10.

Another example method 60 of this disclosure is represented in the block diagram of FIG. 6. In the method 60, a user is presented with a series of images, at 62, and is allowed to indicate its preference for each of the images from the series, at 64. In response to the reaction of the user to the images in the series, the preferences of the user can be determined, at 66. Optionally, the user can then be presented with another subset of images in response to the determined preferences of the user from the initial series of images, at 68. Again, the user is allowed to indicate its preference for each of the images in the subset. The preferences of the user are refined, relative to the initial determined preferences, based on the reaction of the user to the images in the subset.

In one example of the method 60, the initial series of images could be images of model kitchens, and depending on the reaction of the user to the initial series of images, it could be determined that the user likes a certain type of refrigerator (e.g., stainless steel). The subset of images could be images of various types of stainless steel refrigerators. The preferences of the user can thus be refined based on the reaction of the user to the images from the subset.

In still another embodiment of this disclosure, the image presented to the user is in the form of a video. The user is allowed to indicate its preference for certain segments, or portions, of the video. Based on the reaction of the user to the video, the preferences of the user can then be determined. As explained relative to the above embodiment, the preferences of the user can then be refined, if desired, by presenting the user with another video, or with a series of images, based on the response of the user to the initial video.

In any of the above embodiments, the system S captures and store the preferences of the user (e.g., as input at 56 or 64) in a data store (e.g., one or more of data stores 18, 28) and generate a report (e.g., such as the report generated at 58, 66) that provides user preference data. Data collected by the system can be used to generate statistical information that may be analyzed to determine user preference trends. Reports of the statistical information can come in a variety of formats based on a number of different parameters, and can be generated in the same manner as described above. The report itself can be generated by the APP 22 on the server 20, after the APP 14 has completed execution on the computing device 10. Alternatively, or in addition, the report can be generated on demand by invoking a report from the APP 22 via request from the APP 14 on the computing device 10, or the web browser 32 on the configuration computer 30. In another example, the computing device 10 itself generates the report.

The many features and advantages of this disclosure are apparent from the detailed specification, and thus, it is intended by the appended claims to cover all such features and advantages of this disclosure which fall within the true spirit and scope of this disclosure. Further, since numerous modifications and variations will readily occur to those skilled in the art, it is not desired to limit this disclosure to the exact construction and operation illustrated and described, and accordingly, all suitable modifications and equivalents may be resorted to, falling within the scope of this disclosure. For instance, although the method for identifying visual preference makes reference to a touchscreen, this could also apply to computing devices that use a mouse or a stylus or any other pointing device to identify specific user selections and preference.

In addition, although the system, subsystem and method of this disclosure are described as part of the overall disclosure, each of these components can be considered as separate standalone disclosures and the overall as a combination of disclosures. In other words, the method and subsystem described does not necessary need to be combined with the overall system as described to stand alone as unique disclosures. The overall system may be implemented in a variety of embodiments even though the preferred embodiment is described.

Although the different examples have the specific components shown in the illustrations, embodiments of this disclosure are not limited to those particular combinations. It is possible to use some of the components or features from one of the examples in combination with features or components from another one of the examples.

One of ordinary skill in this art would understand that the above-described embodiments are exemplary and non-limiting. That is, modifications of this disclosure would come within the scope of the claims. Accordingly, the following claims should be studied to determine their true scope and content.

What is claimed is:

1. A method for visually identifying user preferences, comprising:
presenting, on a computing device, a user with an image having a plurality of individually selectable portions, the image presented such that the user is allowed to select one or more of the plurality of individually selectable portions; and
determining a preference of the user based on the selections of the user.

2. The method as recited in claim 1, wherein the user is allowed to associate a button icon with one of the individually selectable portions.

3. The method as recited in claim 2, wherein the button icon is one of a LIKE, LOVE, HATE, DISLIKE, CHANGE, WANT, NEED, and LIKE COLOUR button icon.

4. The method as recited in claim 1, wherein the image is an image of a model kitchen, and wherein the individually selectable portions of the image correspond to at least one of fixtures and appliances within a model kitchen.

5. The method as recited in claim 4, wherein the individually selectable portions of the image each correspond to one of: a refrigerator, a stove, a dishwasher, a cabinet, a sink, a backsplash, a countertop, and a range hood.

6. The method as recited in claim 1, wherein the selections of the user are stored in a data store.

7. The method as recited in claim 6, including generating a report based on the selections of the user, the report indicating the determined preference of the user.

8. The method as recited in claim 7, wherein the report is generated by at least one of the computing device and a server, the computing device linked with the server by a network.

9. The method as recited in claim 8, wherein each of the computing device and the server include a central processing unit (CPU), a software application (APP), memory, and a data store.

10. The method as recited in claim 8, wherein the computing device and the server are in communication with a configuration computer having a web browser and memory.

11. The method as recited in claim 1, wherein computing device includes a touch screen, the user allowed to select one or more of the plurality of individually selectable portions by touching the touch screen.

12. The method as recited in claim 11, wherein the computing device is a mobile computing device.

13. The method as recited in claim 1, wherein each of the individually selectable portions are predefined, and correspond to a particular element depicted within the individually selectable portion.

14. A method for visually identifying user preferences, comprising:
presenting, on a computing device, a user with a series of images, the user capable of indicating whether the user likes each image in the series of images; and
determining a preference of the user based on the indications of the user.

15. The method as recited in claim 14, including presenting the user with a subset of images in response to the determined preference of the user, the user capable of indicating whether the user likes each image in the subset of images.

16. The method as recited in claim 15, wherein the determined preference of the user is reevaluated based on which of the images in the subset the user liked.

17. The method as recited in claim 16, including generating a report indicating the determined preference of the user.

18. The method as recited in claim 17, wherein the report is generated by at least one of the computing device and a server, the computing device linked with the server by a network.

19. The method as recited in claim 18, wherein each of the computing device and the server include a central processing unit (CPU), a software application (APP), memory, and a data store.
